(19) United States
(12) Patent Application Publication
(10) Pub. No.: US 2002/0145516 A1
(43) Pub. Date: Oct. 10, 2002

(54) System and method for detection and notification of dangerous environmental situations in a vehicle

(76) Inventors: Paul Andrew Moskowitz, Yorktown Heights, NY (US); Clifford Alan Pickover, Yorktown Heights, NY (US)

Correspondence Address: MCGINN & GIBB, PLLC, 8321 OLD COURTHOUSE ROAD, SUITE 200, VIENNA, VA, 22182-3817, US

(21) Appl. No.: 09/826,819

(22) Filed: Apr. 6, 2001

(51) Int. Cl. G08B 19/00

(52) U.S. Cl. 340/522; 340/541; 340/584; 340/604; 340/577; 340/628

(57) ABSTRACT

A system (and method) includes at least one sensor for sensing a presence of a vehicle occupant, and for sensing a dangerous environmental condition within a vehicle, at least one system for emitting a warning based upon the output of the at least one sensor, and a device for transmitting a signal from the at least one sensor to the warning device.

### BACKGROUND OF THE INVENTION

1. Field of the Invention

The present invention generally relates to a vehicle, and more particularly to a vehicle including a system for detecting the presence of animate objects (e.g., occupants, people, children, pets, etc.), for detecting the existence of a dangerous or life-threatening situation and providing a system for warning the inhabitants of the vehicle and others of the situation.

2. Description of the Related Art

Vehicles, particularly parked automobiles, can be deadly for infants or pets left inside the vehicle on extreme-temperature (i.e., very hot or very cold) days. Unfortunately, such occurrences are too common (e. g., see “Sitter Guilty In Toddler's Heat Death Inside Van”, The Washington Post, Wednesday Apr. 19, 2000, Metro; Page B02). Life threatening or dangerous situations may arise when the temperature inside the vehicle rises above or below a critical value. An additional life-threatening situation is one in which the level of carbon monoxide rises above a critical value. Another is when the vehicle fills with water. Another is when the vehicle is on fire.

Although the above-described phenomena is widespread, hitherto the present invention, there has been no recognition that this is a technical problem that may have a technical solution. Automobiles have been manufactured with systems to warn of open doors, keys in the ignition, lights being left on, etc. Further, sensors have been manufactured to detect the presence and weight of occupants, the nature of the occupant (i.e., human or animal), to measure internal and external temperatures for automobiles, and to detect carbon monoxide in a vehicle. Carbon dioxide detectors may also be purchased for the home.

However, notwithstanding all of the above, it is assumed that it is the vehicle driver's fault if a child is left in the vehicle on a very hot or very cold day, or if a driver dies from carbon monoxide poisoning.

Computer technology for providing information and application functions to automotive vehicles is becoming pervasive. For example, vehicles are being outfitted with computers that control communication devices (e.g., cellular phones, navigation systems) sensors, display and warning devices.

These computerized devices are useful for controlling a vehicle or for the entertainment of the vehicle occupants (e.g., see U.S. patent application Ser. No. 09/311,277 entitled “Information System for Mobile Users”, filed on May 14, 1999, and U.S. patent application Ser. No. 09/357,840, entitled “System and Method for Network Vehicle Diagnostics and Health Monitoring” filed on Jul. 20, 1999, both incorporated herein by reference). Computer technology has been used to control user interface devices such as fax machines, touch screens, speech synthesis and text-to-speech systems, and wireless control device interfaces. Computer technology has been used to detect the presence of drivers and occupants and to adjust the user interface systems of the vehicle (See U.S. Pat. No. 6,181,996, issued Jan. 30, 2001 to Chou et al., incorporated herein by reference).

Such technology has also been used to sense and warn of objects left inadvertently on the surfaces of a vehicle (See U.S. Pat. No. 6,163,250 issued Dec. 19, 2000 to Moskowitz, incorporated herein by reference).

The problem of identifying the presence of occupants in a motor vehicle and the importance of controlling vehicle safety systems has been recognized previously. Identifying occupants in a vehicle is accomplished using a variety of mechanisms. For example, force sensors, ultrasonic detectors, capacitance detectors, optical detectors, and sound detectors have been used. Occupants are detected in order to enable or advise the use of safety devices such as seat belts, air bags, etc.

The problem of detecting external and internal temperatures has been recognized. Such sensors and associated visual displays of the temperature sensed are standard equipment on many vehicles.

The problem of sensing excess carbon monoxide in the home has been recognized. Consumers may purchase carbon monoxide detectors which also provide visual and audio warnings. Such detectors have also been developed for vehicles. Fire detectors, e.g. smoke detectors have been developed for homes and offices. Water detectors have been developed to protect electrical equipment for homes and offices.

However, while the above-described equipment is widespread, there has been no recognition that such computer systems may be used to sense the presence and nature (i.e., adult human, child, pet or animal) of an occupant, to sense that a dangerous condition exists within the vehicle and to provide a warning.

### SUMMARY OF THE INVENTION

In view of the foregoing and other problems, drawbacks, and disadvantages of the conventional methods and structures, the present invention has been devised.

An object of the present invention is to provide a method and structure for detecting the presence of occupants and for the existence of a dangerous or life threatening condition within the vehicle.

It is another object of the invention to detect when an occupant is a non-adult human or an animal or pet, so that others may be properly warned of the dangerous situation.

Additionally, it is an object of the invention to control a device to provide a warning to occupants and others that there exists a dangerous or life-threatening situation.

Further, it is an object of the invention to provide a warning to person(s) other than the vehicle occupants by controlling a warning device that may be observed by a person who is external to the vehicle.

Yet another object of the invention to provide a warning to others than the vehicle occupants by controlling a communications device to provide notice of the dangerous situation to authorities at a remote location.

Additionally, it is an object of the invention to provide remedial action within the vehicle when there exists a dangerous or life-threatening situation.

In a first aspect of the invention, a system for detecting and warning of a dangerous situation includes at least one sensor for sensing the presence of an occupant of a vehicle, and for sensing an environmental parameter, and a controller for controlling a warning device based upon an output signal from the at least one sensor.

Thus, with the unique and unobvious aspects of the invention, the presence of occupants and the existence of a dangerous or life threatening condition within the vehicle, can be detected. Further, it can be detected when an occupant is a non-adult human or an animal or pet, so that others may be properly warned of the dangerous situation.

Further, with the invention, a device can be controlled to provide a warning to occupants and others that there exists a dangerous or life-threatening situation, and a warning can be provided to person(s) other than the vehicle occupants by controlling a warning device that may be observed by a person who is external to the vehicle. Additionally, a warning can be provided to persons others than the vehicle occupants by controlling a communications device to provide notice of the dangerous situation to authorities at a remote location.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a schematic diagram of a vehicle 110 including an animate object (pet, animal) and a device for detecting the presence of such an animate object according to a preferred embodiment of a system 100 of the present invention;

FIG. 2 is a system diagram of components according to the present invention;

FIG. 3 illustrates an exemplary hardware/information handling system 300 for incorporating the present invention therein; and

FIG. 4 illustrates a signal bearing medium (e.g., storage medium) 400 for storing steps of a program for detection and notification of dangerous environmental situations/conditions in a vehicle according to the present invention.

### DETAILED DESCRIPTION OF PREFERRED EMBODIMENTS OF THE INVENTION

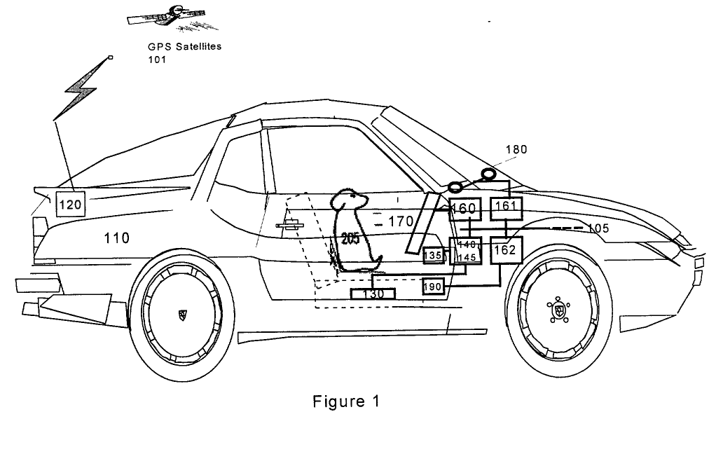

Referring now to the drawings, and more particularly to FIGS. 1-4, there are shown preferred embodiments of the method and structures according to the present invention.

### PREFERRED EMBODIMENT

Referring to FIG. 1, a vehicle system 100 is shown for use with a vehicle 110 and includes an occupant 205 (e.g., a pet, an animal, a person, a child or an infant) seated within the vehicle 110.

The system 100 includes at least one sensor (e.g., sensor circuit) and more preferably a plurality of sensors 130, 135 located at different positions in the vehicle 110, an electronic control unit (ECU) 140 (and more preferably a plurality of ECUs 140, 145) for controlling the sensor circuits, a vehicle communication bus 105 for carrying data and control signals to the ECU 140, an ECU 160 interfaced with the bus 105, and at least one interface device (and more preferably a plurality of interface devices) including, for example, any one or more of a visual display 170, an audio system 180 and the like.

Further, additional devices 190 may be provided, including any one or more of a telecommunications device, a heating device, a cooling device, a ventilation system, a fire extinguisher, etc. A location detector 120 may also be installed to provide information on the vehicle's location to the car bus 105 when used with a system of Global Positioning Satellites (GPS) 101 system. Although the vehicle shown in the diagram is an automobile, other vehicles for which the system may be applied include trucks, buses, boats, mobile homes, elevators, etc.

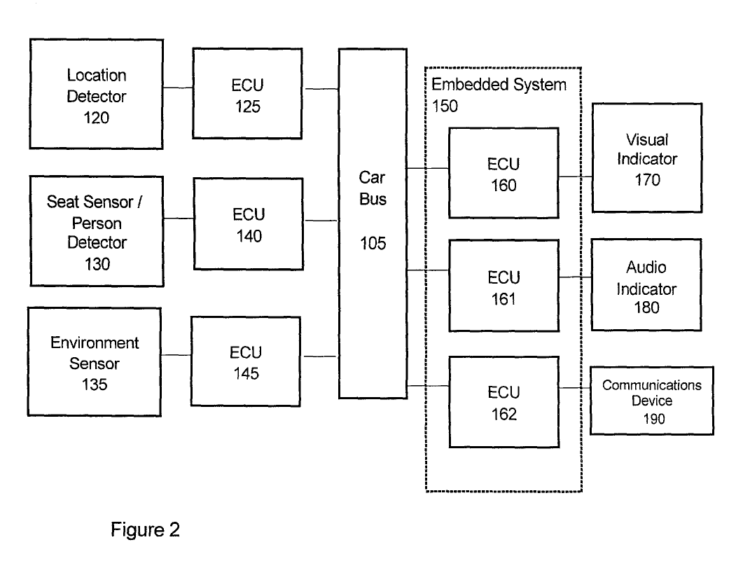

Referring to FIG. 2, a block diagram of the system according to the present invention is shown and is described below.

The system 100 includes a sensor 130 for detecting an occupant (e.g., 205 shown in FIG. 1) located inside of the vehicle 110. The sensors can be formed of known and commercially available components. Many types of sensors may be employed including any one or more of infrared sensors, capacitive sensors, force/pressure sensors, etc., and are well-known in the art. Such sensor components and configurations are described in, for example, U.S. Pat. No. 4,300,116, U.S. Pat. No. 5,402,075, U.S. Pat. No. 5,313,189, U.S. Pat. No. 5,629,488, U.S. Pat. No. 5,871,063, U.S. Pat. No. 5,297,430, U.S. Pat. No. 5,305,644, U.S. Pat. No. 5,857,536, U.S. Pat. No. 5,654,615, U.S. Pat. No. Reissue 034,773, and U.S. Pat. No. 5,602,526, each incorporated herein by reference. Moreover, U.S. Pat. No. 5,404,128, also incorporated herein by reference, describes the detection of an occupant based upon the life activity of the human body including heart beat. Such a system using the distinguishing characteristics of a heart beat (e.g., rate, shape, QRS complex, etc.) may be used to distinguish humans from non-humans.

The system also includes at least one environmental sensor 135 for detecting an environmental condition such as internal or external temperature, carbon monoxide level, vehicle on fire (e.g. smoke, high temperature, carbon monoxide detected by one or more detectors), vehicle filling with water detection, etc., which provides information in digital form to at least one ECU 145.

The system also includes a location detector 120 which provides information in digital form to an ECU 125. The ECUs 125, 140, 145 are coupled to a car bus 105.

The presence of an occupant causes a change in the electrical characteristics of the sensor 130. The sensor's electrical characteristics are monitored by ECU 140, which responds to a change by reporting a detection code over the car bus, such as a Society of Automotive Engineers (SAE) J1850 communication bus, or a Controller Area Network (CAN). The other sensors similarly may report a detection code representing the parameters detected to the car bus 105. The car bus 105 in turn provides the code to a second set of ECUs 160, 161, 162 which control devices 170, 180, 190.

The ECUs 160, 161, 162 and additional ECUs, as necessary, may be provided as components within an embedded electronic or computing system 150 within the vehicle. The interface may control visual and/or audio systems 170, 180, and a communication system 190.

Thus, if a dangerous situation is detected (e.g., a child or pet is in a stationary vehicle and the temperature has exceeded a critical level), the communications system may be instructed to send a warning or call for help (e.g., a 911 call to police or call for help to a service center).

Additionally, ECUs may be provided to activate and control heating, ventilating, cooling systems, and fire extinguishers. In the case where the temperature is too high or too low, cooling and heating systems may be activated automatically, respectively. In the case of a high level of carbon monoxide, the ventilation system may be activated to introduce outside air (e.g., “fresh” air). In the case of a fire, a fire extinguisher may be activated.

The audio indicator 180 may be a warning device inside the vehicle or one that may be observed outside the vehicle (e.g., a car horn honking, etc.). The visual indicator 170 may be a warning device inside the vehicle or one that may be observed outside the vehicle (e.g., car headlights flashing, etc.).

Similar sensors and ECUs may be used to detect whether the vehicle is in motion or not, or whether the engine is on or off. Such information may be analyzed by an embedded computing system 150 according to an algorithm stored in that system.

The embedded system 150 may enable cooling, heating, ventilation, and the use of internal and external warning devices, as well as initiating a call for help through the use of a communications device 190 (e.g., a cell phone). The information provided by the communications device within the call for help may include vehicle identification number (VIN), manufacturer, model and color of the vehicle, location of the vehicle, parameters characterizing the dangerous situation, and information on the occupant of the vehicle (e.g., adult human, child, pet, or other animal, personal information about the occupants, etc.). Personal information about the occupants may include medical history, age, sex, or other demographic information.

FIG. 3 illustrates a typical hardware configuration of an information handling/computer system which can be used with the invention and which preferably has at least one processor or central processing unit (CPU) 311.

The CPUs 311 are interconnected via a system bus 312 to a random access memory (RAM) 314, read-only memory (ROM) 316, input/output (I/O) adapter 318 (for connecting peripheral devices such as disk units 321 and tape drives 340 to the bus 312), user interface adapter 322 (for connecting a keyboard 324, mouse 326, speaker 328, microphone 332, and/or other user interface device to the bus 312), a communication adapter 334 for connecting an information handling system to a data processing network, the Internet, an intranet, a personal area network (PAN), etc., and a display adapter 336 for connecting the bus 312 to a display device 338 and/or printer 339.

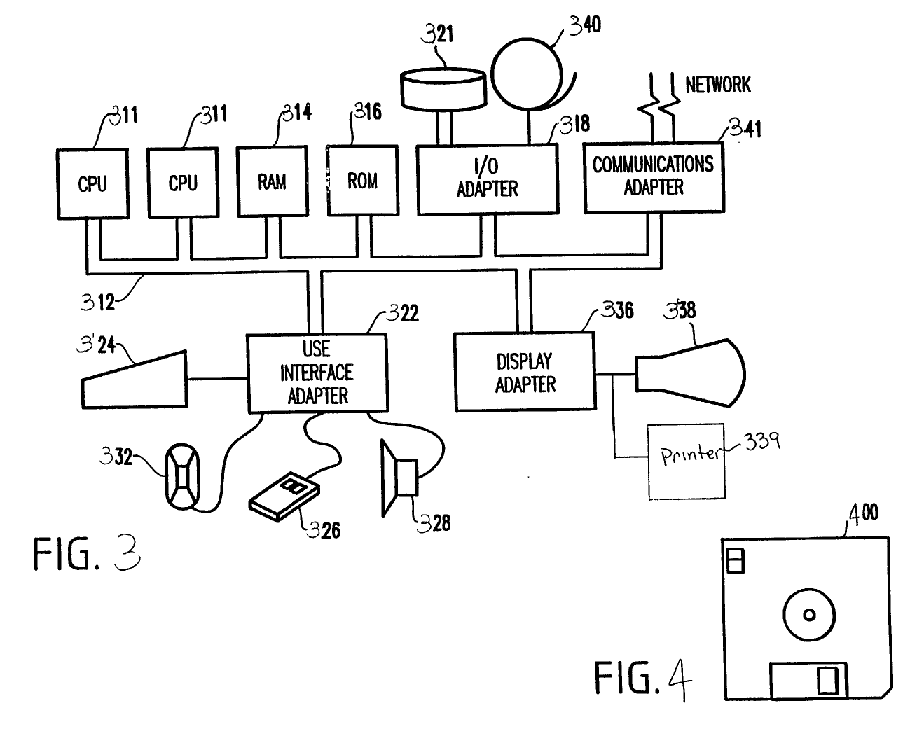

Thus, as shown in FIG. 4, in addition to the hardware and process environment described above, a different aspect of the invention includes a computer-implemented method according to the present invention, as described above. As an example, this method may be implemented in the particular hardware environment discussed above.

Such a method may be implemented, for example, by operating the CPU 311 (FIG. 3), to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 311 and hardware above, to perform the method of the invention.

This signal-bearing media may include, for example, a RAM contained within the CPU 311, as represented by the fast-access storage for example. Alternatively, the instructions may be contained in another signal-bearing media, such as a magnetic data storage diskette 400 (FIG. 4), directly or indirectly accessible by the CPU 311.

Whether contained in the diskette 400, the computer/CPU 311, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Thus, as described above, the present invention provides a system in which the presence of occupants and the existence of a dangerous or life threatening condition within the vehicle, can be detected. Further, it can be detected when an occupant is a non-adult human or an animal or pet, so that others may be properly warned of the dangerous situation. Additionally, the inventive device can be controlled to provide a warning to occupants and others that there exists a dangerous or life-threatening situation, and a warning can be provided to person(s) other than the vehicle occupants by controlling a warning device that may be observed by a person who is external to the vehicle. Moreover, the warning can be provided to persons others than the vehicle occupants by controlling a communications device to provide notice of the dangerous situation to authorities at a remote location.

When the system described above is installed in vehicles, lives will be saved. As a result, given the rise in personal safety (and thus reduction of claims) it will be advantageous for insurance companies to give users of the system incentives for the installation of the system. It may also be advantageous for the government to give manufacturers of the system incentives for the incorporation of the system in vehicles.

While the invention has been described in terms of several preferred embodiments, those skilled in the art will recognize that the invention can be practiced with modification within the spirit and scope of the appended claims.

What is claimed is:

1. A system, comprising:
at least one sensor for sensing a presence of a vehicle occupant, and for sensing a dangerous environmental condition within a vehicle;
at least one system for emitting a warning based upon the output of said at least one sensor; and
a device for transmitting a signal from said at least one sensor to said warning device.

2. The system of claim 1, wherein the occupant includes at least one of an adult human, a child, a pet, and a non-pet animal.

3. The system of claim 1, wherein said vehicle comprises one of an automobile, a truck, a bus, a boat, a mobile home, and an elevator.

4. The system of claim 1, wherein said dangerous environmental condition comprises one of high temperature, low temperature, high carbon monoxide level, said vehicle on fire, and said vehicle filling with water.

5. The system of claim 1, wherein said at least one system for emitting a warning comprises a visual warning indicator.

6. The system of claim 5, wherein said visual warning indicator comprises at least one of an indicator light and flashing headlights of said vehicle.

7. The system of claim 1, wherein said at least one system for emitting a warning comprises an audio warning indicator.

8. The system of claim 7, wherein said audio warning indicator comprises at least one of a buzzer internal to said vehicle and a car horn honking external to said vehicle.

9. The system of claim 1, wherein said at least one system for emitting a warning comprises a communications device.

10. The system of claim 9, wherein the communications device comprises a cellular phone.

11. The system of claim 9, wherein the communications device transmits information containing at least one of vehicle identification number (VIN), a manufacturer of the vehicle, a model of the vehicle, and a color of the vehicle, a location of the vehicle, parameters characterizing the dangerous environmental situation, information regarding the occupant of the vehicle, and personal information regarding the occupant of the vehicle.

12. The system of claim 11, wherein said information regarding the occupant of the vehicle comprises information regarding whether said occupant is an adult human, a child, a pet, or a non-pet animal.

13. The system of claim 1, wherein the vehicle comprises one of a stationary vehicle and a vehicle in motion.

14. The system of claim 1, further comprising:
a system to activate one of a cooling device, a heater, a fire extinguisher, and a ventilator.

15. The system of claim 1, further comprising:
an incentive-providing system for providing an incentive for installation of the system.

16. The system of claim 1, further comprising:
an incentive-providing system for providing an incentive for use of the system.

17. The system of claim 1, wherein said at least one sensor comprises a first sensor for sensing a presence of said occupant and a second sensor for sensing said dangerous environmental condition.

18. The system according to claim 1, wherein a plurality of ones of said at least one sensor are provided at predetermined positions in said vehicle.

19. The system according to claim 1, wherein said device comprises an electronic control unit (ECU) for processing said output signal from said at least one sensor.

20. The system according to claim 19, wherein said device further comprises a vehicle communication bus for carrying data to said electronic control unit.

21. The system according to claim 20, wherein said device comprises a plurality of electronic control circuits connected to said vehicle communication bus.

22. The system according to claim 21, wherein said plurality of electronic control circuits connected to said vehicle communication bus are selectively interfaced with a plurality of devices.

23. The system according to claim 1, wherein said at least one sensor senses a weight of a passenger and outputs a value representing said weight to said device.

24. The system according to claim 20, wherein said bus comprises one of a Society of Automotive Engineers (SAE) J1850 bus and a Controller Area Network bus.

25. The system according to claim 22, wherein said plurality of devices comprise at least one of a visual display device, an audio system, a telecommunications device, a fax machine, a touch screen, a speech synthesis device, a text-to-speech interface, a wireless control device, a ventilation device, a heating device, a cooling device, and a fire extinguisher.

26. The system according to claim 1, wherein said at least sensor includes a sensor for sensing a heartbeat of said occupant of said vehicle.

27. The system according to claim 26, wherein said sensor senses a heartbeat pattern of said occupant and whether said heartbeat pattern includes a predetermined shape.

28. A system for detecting and warning of a dangerous situation in a vehicle, comprising:
at least one sensor for sensing the presence of an occupant of a vehicle, and for sensing a dangerous environmental parameter; and
a controller for controlling a warning device based upon an output signal from the at least one sensor.

29. A method, comprising:
sensing a presence of a vehicle occupant;
sensing a dangerous environmental condition within a vehicle;
emitting a warning, by a warning device, based upon the sensing of said presence and said sensing of said dangerous environmental condition; and
transmitting a signal to said warning device.

30. A signal-bearing medium tangibly embodying a program of machine-readable instructions executable by a digital processing apparatus to perform a method for computer-implemented detection and notification of dangerous environmental conditions in a vehicle, said method comprising:
sensing a presence of a vehicle occupant;
sensing a dangerous environmental condition within a vehicle;
emitting a warning, by a warning device, based upon the sensing of said presence and said sensing of said dangerous environmental condition; and
transmitting a signal to said warning device.
